(19) United States
(12) Patent Application Publication
(10) Pub. No.: US 2026/0223762 A1
(43) Pub. Date: Aug. 6, 2026

(54) Agricultural Implement and Related Method

(71) Applicant: AGCO Corporation, Duluth, GA (US)

(72) Inventors: Benjamin Anson Fanshier, Hesston, KS (US); Robert L. Figger, Hesston, KS (US); Jarret Lee Brinker, Beloit, KS (US); Ross Duerksen, Hesston, KS (US)

(21) Appl. No.: 19/128,898

(22) PCT Filed: Oct. 12, 2023
(86) PCT No.: PCT/IB2023/060316

§ 371 Date: May 9, 2025

Related U.S. Application Data
(60) Provisional application No. 63/384,315, filed on Nov. 18, 2022.

(51) Int. Cl. A01B 73/04; A01B 63/32; A01B 79/02; A01C 7/20

(52) U.S. Cl. CPC A01B 73/044; A01B 63/32; A01B 79/02; A01C 7/201

(57) ABSTRACT

An agricultural implement (104) includes a frame (106), a center toolbar (116) carried by the frame and carrying a first row unit (200), a first sensor (216, 218) configured to sense a position of the first row unit relative to ground (220), an intermediate member (124) pivotally coupled to the center toolbar, a wing toolbar (118) pivotally coupled to the intermediate member and carrying a second row unit, a second sensor (216, 218) configured to sense a position of the second row unit relative to the ground, a first actuator 2024/105474 (126) configured rotate the intermediate member relative to the center toolbar, a second actuator (128) configured to rotate the wing toolbar relative to the intermediate member, and a control system (120). The control system controls the first and second actuators based at least in part on the sensed positions of the first and second row units when the implement is in a field-operation mode. A related method is also disclosed.

WO

### CROSS-REFERENCE TO RELATED APPLICATIONS

This application claims the benefit of the filing date of U.S. Provisional Patent Application 63/384,315, “Agricultural Implements and Related Methods and Systems,” filed Nov. 18, 2022, the entire disclosure of which is incorporated herein by reference.

### FIELD

Embodiments of the present disclosure relate generally to machines and methods for working agricultural fields. In particular, embodiments relate to implements (e.g., planters, tillage, etc.) and to methods of controlling such implements.

### BACKGROUND

Crop yields are affected by a variety of factors, such as seed placement, soil quality, weather, irrigation, and nutrient applications. Seeds are typically planted in trenches formed by discs or other mechanisms of a planter row unit. Depth of seed placement is important because seeds planted at different depths emerge at different times, resulting in uneven crop growth. Trench depth can be affected by soil type, moisture level, row unit speed, and operation of the opening discs.

Row units are typically spaced along a toolbar of a planter, which may include multiple sections. For example, a 3-section planter has a center section, a left wing section, and a right wing section, each having several ground-engaging row units. A 3-section planter may have a nominal working width from about 30 ft (9.1 m) to about 40 ft (12.2 m), but can be wider or narrower.

To transport such a planter along roads, it is helpful to fold the wing sections. For example, the left and right wing sections may each rotate upward from the center section, as depicted in U.S. Pat. No. 11,229,152, “Ground-engaging Implement with Lateral Position Adjustment,” granted Jan. 25, 2022. As another example, the left and right wing sections may fold horizontally rearward of the center section, as depicted in U.S. Pat. No. 4,646,851, “Bi-fold Toolbar,” granted Mar. 3, 1987.

Furthermore, the left and right wing sections may fold to be above the center section, as shown in U.S. Pat. No. 8,807,236, “Agricultural Implement Incorporating Stack-fold Planter,” granted Aug. 19, 2014.

To support a planter over the ground, current planters typically use tire structures. In the center section, the tires support the frame and help the planter match the terrain. The wing sections also typically have tires. When the tires contact the ground, it makes the planter “ride” the terrain. However, the tires can only push up or down on the existing mechanical system and can only flex in a way the frame allows. Further, tires can create zones of compaction that negatively affect plant growth.

### BRIEF SUMMARY

In some embodiments, an agricultural implement includes a frame; a center toolbar carried by the frame and carrying a first ground-engaging row unit; a first sensor configured to sense a position of the first ground-engaging row unit relative to ground; an intermediate member pivotally coupled to the center toolbar; a wing toolbar pivotally coupled to the intermediate member and carrying a second ground-engaging row unit; a second sensor configured to sense a position of the second ground-engaging row unit relative to the ground; a first actuator configured rotate the intermediate member relative to the center toolbar; a second actuator configured to rotate the wing toolbar relative to the intermediate member; and a control system. The control system is configured to control the first actuator and the second actuator based at least in part on the sensed positions of the first and second ground-engaging row units when the implement is in a field-operation mode.

The intermediate member typically carries no ground-engaging row units.

The first and/or second actuators may comprise hydraulic cylinders.

The control system may be configured to maintain the second row unit at a same position relative to the ground as the first row unit.

In some embodiments, the control system is configured to receive a signal to switch from the field-operation mode to a transport mode, and the control system is configured in the transport mode to cause the first and second actuators to position the wing toolbar at least partially above the center toolbar.

In some embodiments, the first ground-engaging row unit is coupled to the center toolbar by a first parallel linkage, and the second ground-engaging row unit is coupled to the wing toolbar by a second parallel linkage. The first sensor may comprise a rotary sensor configured to measure an angle of an element of the first parallel linkage, and the second sensor may comprise a rotary sensor configured to measure an angle of an element of the second parallel linkage.

In some embodiments, the first sensor and the second sensor each comprise an ultrasonic, lidar, or radar sensor.

The control system may also comprise at least one component such as a control valve, an air valve, an electronic control component, a magnetic control component, and/or an electromagnetic control component.

The agricultural implement may include another intermediate member pivotally coupled to the center toolbar; another wing toolbar pivotally coupled to the another intermediate member and carrying a third ground-engaging row unit; a third sensor configured to sense a position of the third ground-engaging row unit relative to the ground; a third actuator configured rotate the another intermediate member relative to the center toolbar; and a fourth actuator configured to rotate the another wing toolbar relative to the another intermediate member. The control system may also be configured to control the third actuator and the fourth actuator based at least in part on the sensed positions of the first and third ground-engaging row units when the implement is in the field-operation mode.

Some embodiments include a computer-implemented method for operating an implement that comprises a frame, a center toolbar carried by the frame and carrying a first ground-engaging row unit, an intermediate member pivotally coupled to the center toolbar, and a wing toolbar pivotally coupled to the intermediate member and carrying a second ground-engaging row unit. The method comprises receiving an indication of a position of the first ground-engaging row unit relative to ground sensed by a first sensor; receiving an indication of a position of the second ground-engaging row unit relative to the ground sensed by a second sensor; causing a first actuator to rotate the intermediate member relative to the center toolbar; and causing a second actuator to rotate the wing toolbar relative to the intermediate member. The first actuator and the second actuator are controlled based at least in part on the sensed positions of the first and second ground-engaging row units when the implement is in a field-operation mode.

The method may also include sensing positions of the center toolbar and the wing toolbar relative to the ground.

Causing the first actuator to rotate the intermediate member relative to the center toolbar may comprise sending a first control signal to a first control component associated with the first actuator, and causing the second actuator to rotate the wing toolbar relative to the intermediate member may comprise sending a second control signal to a second control component associated with the second actuator.

Receiving the indication of the first position of the first ground-engaging row unit relative to the ground sensed by the first sensor may comprise receiving a first signal from the first sensor, and receiving the indication of the second position of the second ground-engaging row unit relative to the ground sensed by the second sensor may comprise receiving a second signal from the second sensor.

Some embodiments include a non-transitory computer-readable storage medium, the computer-readable storage medium including instructions that when executed by a control system associated with an agricultural implement that comprises a frame, a center toolbar carried by the frame and carrying a first ground-engaging row unit, an intermediate member pivotally coupled to the center toolbar, and a wing toolbar pivotally coupled to the intermediate member and carrying a second ground-engaging row unit, cause the control system to perform any of the computer-implemented methods described herein.

### BRIEF DESCRIPTION OF THE DRAWINGS

While the specification concludes with claims particularly pointing out and distinctly claiming what are regarded as embodiments of the present disclosure, various features and advantages of embodiments of the disclosure may be more readily ascertained from the following description of example embodiments when read in conjunction with the accompanying drawings, in which:

FIG. 1 is a simplified top view of a tractor pulling an implement;

FIG. 2 is a simplified side view of a row unit that may be carried by the implement shown in FIG. 1;

FIG. 3 is a simplified rear view of the implement shown in FIG. 1 on level ground;

FIG. 4 is a simplified rear view of the implement shown in FIG. 1 on sloped ground;

FIG. 5 is a simplified rear view of the implement shown in FIG. 1 on terraced ground;

FIG. 6 is a simplified rear view of the implement shown in FIG. 1 folded for transport;

FIG. 7 is a simplified flow chart illustrating a method of operating an implement;

FIG. 8 illustrates an example computer-readable storage medium comprising processor-executable instructions configured to embody one or more methods of operating an agricultural implement, such as the method illustrated in FIG. 7; and

FIG. 9 is a simplified drawing showing an angle sensor that may be used in the implement shown in FIG. 1.

### DETAILED DESCRIPTION

The illustrations presented herein are not actual views of any implement or portion thereof, but are merely idealized representations that are employed to describe example embodiments of the present disclosure. Additionally, elements common between figures may retain the same numerical designation.

The following description provides specific details of embodiments of the present disclosure in order to provide a thorough description thereof. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all elements to form a complete structure or assembly. Only those process acts and structures necessary to understand the embodiments of the disclosure are described in detail below. Additional conventional acts and structures may be used. Also note, the drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter).

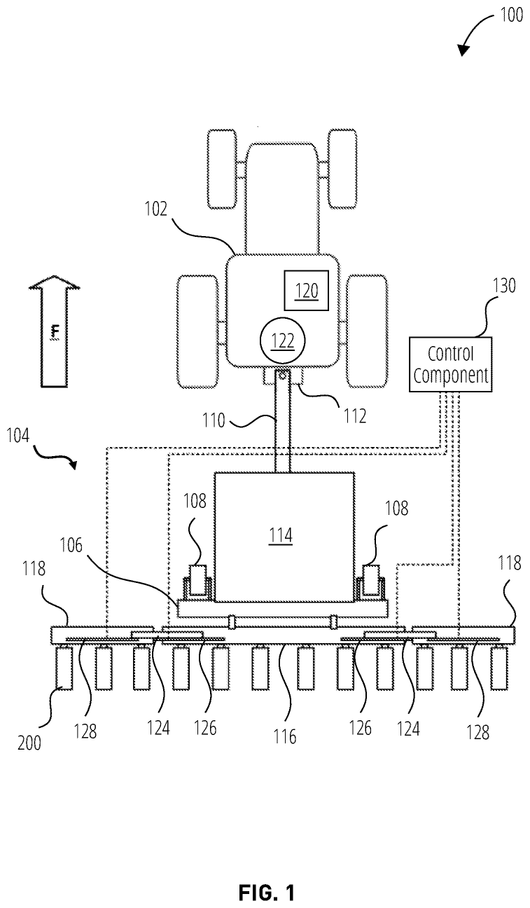

FIG. 1 illustrates a system 100 that includes a tractor 102 drawing an agricultural implement 104 with row units 200 in a field along a forward direction F. The agricultural implement 104 may have a frame 106 supported by one or more wheels 108, and a tongue 110 connected at the forward end to a tow hitch 112 of the tractor 102. The frame 106 may carry a material hopper 114 configured to provide material to the row units 200 (e.g., seeds, fertilizer, etc.).

The wheels 108 may support substantially all of the weight of the agricultural implement 104, including material in the material hopper 114. In some embodiments, the tractor 102 may support all or a portion of the weight of the agricultural implement 104 via the tow hitch 112 thereon, and the wheels 108 may be omitted. Typically, the row units 200 do not support significant weight of the agricultural implement 104, though the row units 200 may exert a force on the ground during operation. In certain embodiments, the weight of the agricultural implement 104 may be borne by the tow hitch 112 (e.g., if the tow hitch 112 is a 3-point hitch).

The agricultural implement 104 has a toolbar carrying the row units 200. In the embodiment shown in FIG. 1, the toolbar is divided into three sections: a center toolbar 116 connected to the frame 106, and two wing toolbars 118 connected to opposite lateral ends of the wing toolbar 118. In other embodiments, there may be two wing toolbars on the left of the center toolbar 116 and two wing toolbars on the right (i.e., one toolbar connected to the end of another on each side).

The center toolbar 116 may be configured to move relative to the frame 110 to adjust the position of row units 200 carried by the center toolbar 116 relative to a ground surface. For example, the center toolbar 116 may be connected to the frame 106 as described in U.S. Patent Application Publication 2020/0084951A1, “Implement Contouring Toolbar,” published Mar. 19, 2020.

A control system 120, which may include a central processing unit (“CPU”), memory, and graphical user interface (“GUI”) (e.g., a touch-screen interface), is typically located in the cab of the tractor 102. A global positioning system (“GPS”) receiver 122 may be mounted to the tractor 102 and connected to communicate with the control system 120. The control system 120 may be configured to communicate with the agricultural implement 104 and/or with each individual row unit 200, such as by wired or wireless communication. Various control components 130 may communicate with the control system 120 and control various aspects of the agricultural implement 104. For example, the control components 130 may include, without limitation, control valves, air valves, electronic control components, magnetic control components, and/or electromagnetic control components.

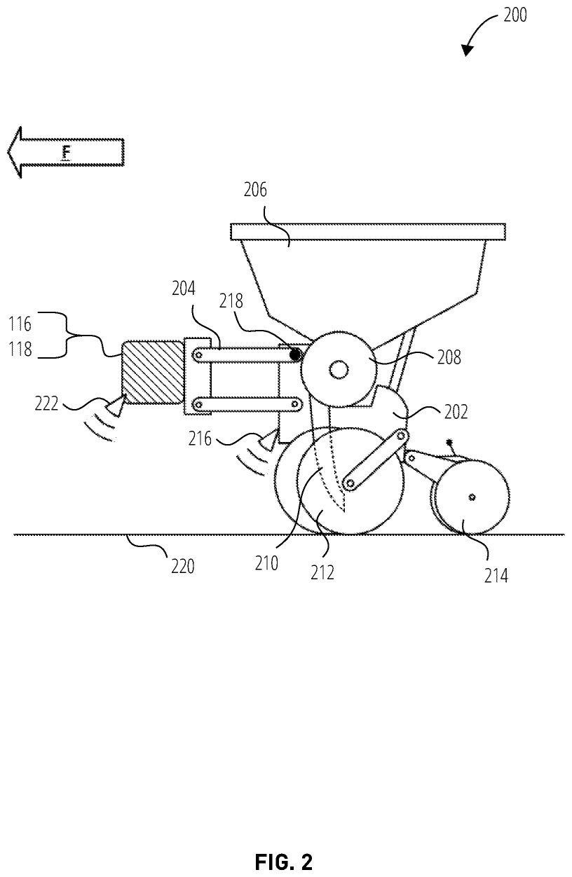

The row units 200 may be any type of ground-engaging device for planting, seeding, fertilizing, tilling, or otherwise working crops or soil, typically in rows. As an example, FIG. 2 is a simplified side view illustrating a single row unit 200 in the form of a planter row unit. The row unit 200 has a body 202 connected to the toolbar (e.g., the center toolbar 116 or one of the wing toolbar 118) by a parallel linkage 204, enabling the row unit 200 to move vertically independent of the toolbar. In some embodiments, the body 202 of the row unit 200 may be connected to the toolbar 116, 118 by another structure, such as a rotating arm. The body 202 may be a unitary member, or may include one or more members coupled together (e.g., by bolts, welds, etc.). The body 202 operably supports one or more of a hopper 206, a seed meter 208, a seed delivery mechanism 210, a seed trench opening assembly 212, a trench closing assembly 214, and/or any other components as known in the art. It should be understood that the row unit 200 shown in FIG. 2 may optionally be a part of a central fill planter, in which case the hopper 206 may be one or more mini-hoppers fed by the material hopper 114 (FIG. 1) carried by the agricultural implement 104. In other embodiments, the material hopper 114 may be omitted, and each row unit 200 may simply use its own hopper 206 alone.

At least one sensor 216, 218 may be used to determine a position of a row unit 200 relative to the ground surface 220 or toolbar 116, 118. As shown in FIG. 2, the sensors 216, 218 may be carried on the body 202 of the row unit 200 itself. In other embodiments, sensors 216, 218 may be carried by the toolbar 116, 118, the frame 106 of the agricultural implement 104, the tractor 102, or even by another vehicle (e.g., another ground vehicle, an unmanned aerial vehicle, etc.). The sensor 218 may be a rotary sensor configured to measure an angle of an element of the parallel linkage 204 relative to the body 202 of the row unit 200 or to the toolbar 116, 118, and may be connected to a pivot point of the body 202 of the row unit 200 or to the toolbar 116, 118. The sensor 216 depicted may include a non-contact depth sensor, for example, an optical sensor, an ultrasonic transducer, an RF (radio frequency) sensor, lidar, radar, etc. Such sensors are described in, for example, U.S. Pat. No. 10,874,042, “Seed Trench Depth Detection Systems,” granted Dec. 29, 2020. The sensors 216, 218 may provide information that can be used to adjust the position of the toolbars 116, 118.

In some embodiments, an additional sensor 222 may be configured to detect the position of the toolbar 116, 118 relative to the ground surface 220.

The agricultural implement 104 traveling through a field in the forward direction F may encounter variations in field elevation and/or slope. The sensors 216, 218, 222, detect the position of the row units 200 and/or the toolbars 116, 118, relative to the ground surface 220, and send signals to the control system 120 (FIG. 1).

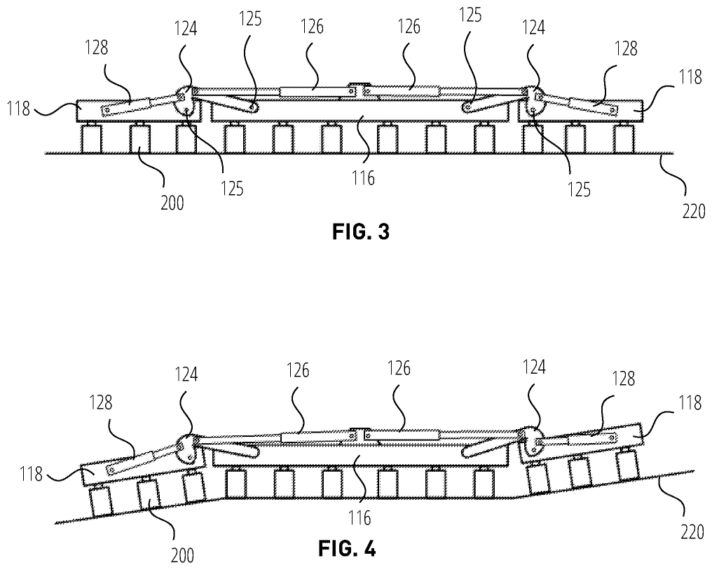

FIG. 3 is a simplified rear view of the toolbars 116, 118 of the agricultural implement 104 operating in a field over the ground surface 220. Note that some elements of the agricultural implement 104 have been omitted from view, such as the material hopper 114 and the wheels 108. The tractor 102 is also not depicted in FIG. 3, so that parts of the agricultural implement 104 may be more clearly shown.

As discussed above, the toolbars include the center toolbar 116 and two wing toolbars 118, though additional wing toolbars may optionally be added at the end of the two wing toolbars 118 shown, using similar connection mechanisms.

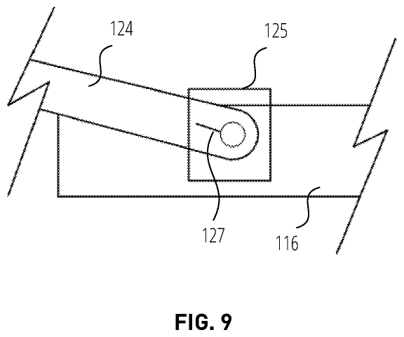

Each wing toolbar 118 is connected to the center toolbar 116 by an intermediate member 124. Each intermediate member 124 is pivotally coupled to the center toolbar 116 and to the respective wing toolbar 118. The intermediate members 124 enable rotational and vertical movement of the wing toolbars 118 relative to the center toolbar 116. The intermediate members 124 carry no row units, but are used to enable the wing toolbars 118 to be positioned relative to the center toolbar 116 as described in further detail below. In some embodiments, the orientation of the intermediate members 124 relative to the center toolbar 116 and corresponding wing toolbar 118 may be measured by angle sensors 125, as shown in FIG. 9. The angle sensors 125 may be, for example, a magnetic sensor, a shaft-type sensor, a rotary sensor, etc. The angle sensors 125 may include a potentiometer having an arm 127 configured to rotate with intermediate member 124 relative to the toolbar 116, 118 (or with the toolbar 116, 118 relative to the intermediate member 125). The angle sensors 125 may be at any or all of the pivot joints between the intermediate member 124 and toolbars 116, 118.

A first, inner actuator 126 is configured rotate the intermediate member 124 relative to the center toolbar 116, and a second, outer actuator 128 is configured to rotate the wing toolbar 118 relative to the intermediate member 124. The actuators 126, 128 may include, for example, hydraulic cylinders, electric motors, pneumatic actuators, etc. Together, the actuators 126, 128 control the position and orientation of the wing toolbar 118 relative to the center toolbar 116. When the agricultural implement 104 is in a field-operation mode, the control system 120 is configured to control the actuators 126, 128 based at least in part on positions of the row units 200, as sensed by the sensor 216, 218 (FIG. 2). Typically, the selected position and orientation of the wing toolbar 118 relative to the center toolbar 116 is based at least in part on at least one row unit 200 on each of the center toolbar 116 and the corresponding wing toolbar 118. However, in some embodiments, the position of any number of row units 200 may be used to select the position and orientation of the wing toolbars 118, even up to and including the position of every row unit 200.

The wing toolbars 118 may thus be positioned and oriented to be approximately parallel to the portion of the ground surface 220 over which that wing toolbar 118 is traveling.

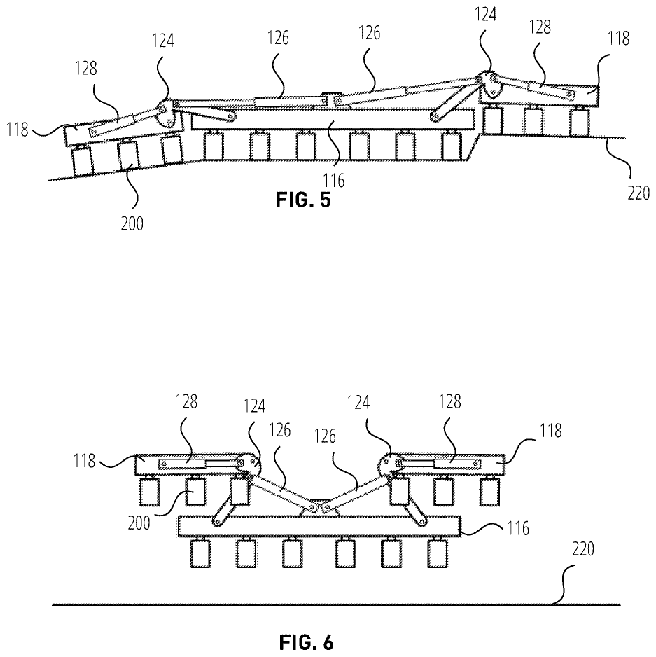

FIG. 4 is a simplified rear view of the toolbars 116, 118 of the agricultural implement 104 operating over a sloped portion of the ground surface 220. As shown, the left wing toolbar 118 may be oriented downward, the right wing toolbar 118 may be oriented upward, and the center toolbar 116 may be level. Because the left and right wing toolbars 118 can move independently from one another, both may be angled to match the terrain. Because the agricultural implement 104 can match the angle of the toolbars 116, 118 to the slope in fields, the position of each row unit 200 can better match the ground surface 220, and the agricultural implement 104 may increase yield in the field as compared to conventional implements.

Each of the row units 200 can move independently of the toolbars 116, 118, to compensate for smaller variations in the ground surface 220 (e.g., slope changes between one end a particular section of the toolbar). That is, even if a particular wing toolbar 118 is not parallel to the ground surface 220 over its entire span, the parallel linkages 204 connecting the row units 200 to the wing toolbar 118 can each adjust different amounts as necessary to keep each row unit 200 in position (typically, to plant seeds at the same depth in every row).

FIG. 5 is a simplified rear view of the toolbars 116, 118 of the agricultural implement 104 operating over a terraced ground surface 220. As shown, the left wing toolbar 118 may be oriented downward, the right wing toolbar 118 may be approximately level, and the center toolbar 116 may be level. The right wing toolbar 118 is shown as positioned higher to match a terrace step in the ground surface 220. Because the wing toolbars 118 are connected to the intermediate members 124, rather than directly to the center toolbar 116, the inside ends of the wing toolbars 118 need not be at the same elevations as the ends of the center toolbar 116 (e.g., as depicted in FIG. 5 for the right wing toolbar 118).

FIG. 6 is a simplified rear view of the toolbars 116, 118 of the agricultural implement 104 in a transport position. Note that because the tractor 102 and the frame 106 of the agricultural implement 104 are omitted from view, the row units 200 are depicted as floating above the ground surface 220. The toolbars 116, 118, are in fact supported by the frame 106 (which is itself supported by the wheels 108 (if present) and/or the tractor 102).

The inner actuators 126 rotate the intermediate members 124 to move the wing toolbars 118 over the center toolbar 116. The outer actuators 128 may adjust the angle of the wing toolbars 118 to be approximately parallel to the center toolbar 116. Thus, the agricultural implement 104 is narrower for transport (e.g., over a public roadway), but is not as tall as it would be if the wing toolbars 118 were simply rotated upward. Furthermore, because the row units 200 remain approximately upright in the configuration shown in FIG. 6, material may remain in the material hoppers 114 without spilling. This folded configuration may be beneficial where overhead obstructions are present (e.g., power lines, bridges, etc.), and when material remains in the material hoppers 114. Thus, the agricultural implement 104 as shown has more options for transport than conventional implements.

The shape and size of the intermediate members 124 may be selected such that the wing toolbars 118 can be arranged in certain orientations. For example, and as shown in FIG. 3 through FIG. 6, the intermediate members 124 may have a J-shape to enable pin connections to the wing toolbars 118, the center toolbar 116, and the actuators 126, 128 at appropriate positions. Because the intermediate members 124 do not carry row units 200, they can be positioned generally above the center toolbar 116 and wing toolbars 118, or at an angle to the center toolbar 116 and wing toolbars 118. The intermediate members 124 can have other general shapes, such as generally linear, U-shaped, V-shaped, etc.

The control system 120 (FIG. 1) may be configured to maintain, as nearly as possible, each of the row units 200 at the same position relative to the ground surface 220. This may be brought about by moving the center toolbar 116, the wing toolbars 118, and or the parallel linkages 204 of the row units 200. These adjustments enable more of the row units 200 to be maintained at a selected position relative to the ground surface 220 than conventional implements. The control system 120 may use information from the row units 200 (e.g., from sensors 216, 218, 222) and/or from the angle sensors 125 to determine target positions of the toolbars 116, 118. The control system 120 may use any number or type of control components 130 to operate the actuators 126, 128, such as control valves, air valves, electronic control components, magnetic control components, electromagnetic control components, etc.

Upon receipt of a signal (typically from an operator of the tractor 102), the control system 120 may switch from a field-operation mode to a transport mode and cause the actuators 126, 128 to position the wing toolbars 118 at least partially above the center toolbar 116, as depicted in FIG. 6.

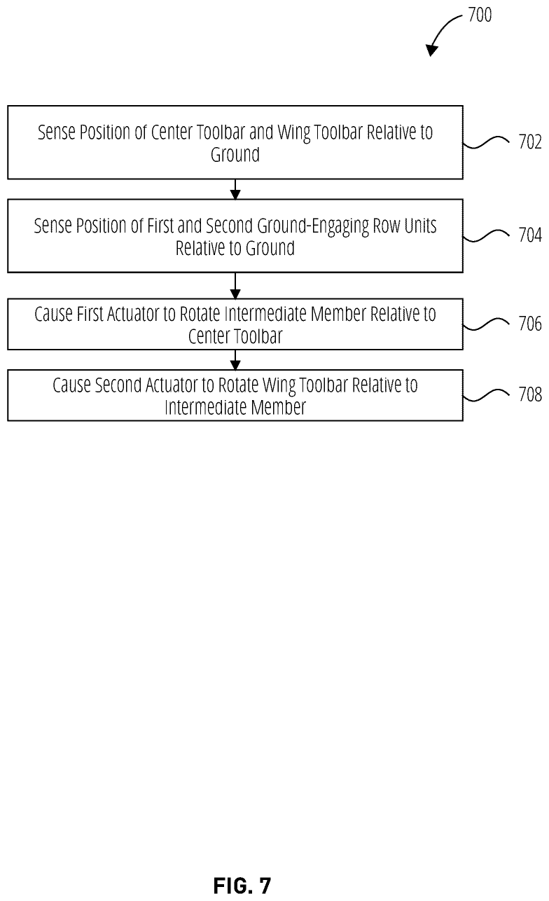

FIG. 7 is a simplified flow chart illustrating a computer-implemented method 700 of using the agricultural implement 104 to work an agricultural field. In block 702, the method 700 includes sensing positions of the center toolbar and the wing toolbar relative to the ground. In block 704, the position of first and second ground-engaging row units are sensed relative to ground by first and second sensors. In block 706, a control component causes a first actuator to rotate the intermediate member relative to the center toolbar (e.g., by a control system sending a control signal to the control component). In block 708, a control component causes a second actuator to rotate the wing toolbar relative to the intermediate member (e.g., by a control system sending a control signal to the control component). The first and second actuators are controlled based at least in part on the sensed positions of the first and second ground-engaging row units when the implement is in a field-operation mode, and optionally, in part on the sensed positions of the center toolbar and wing toolbar relative to the ground.

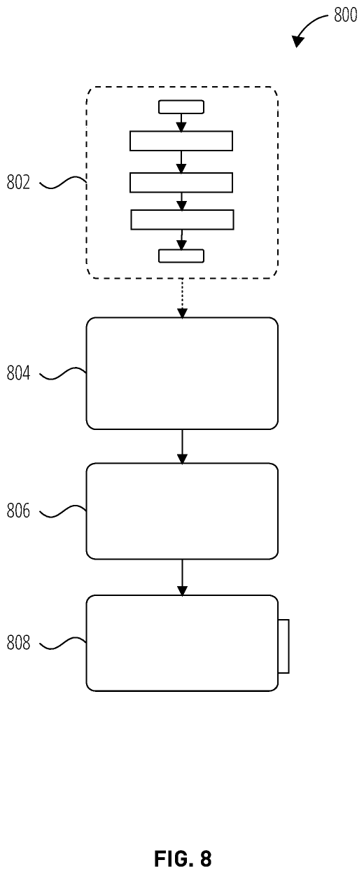

Still other embodiments involve a computer-readable storage medium (e.g., a non-transitory computer-readable storage medium) having processor-executable instructions configured to implement one or more of the techniques presented herein. An example computer-readable medium that may be devised is illustrated in FIG. 8, wherein an implementation 800 includes a computer-readable storage medium 802 (e.g., a flash drive, CD-R, DVD-R, application-specific integrated circuit (ASIC), field-programmable gate array (FPGA), a platter of a hard disk drive, etc.), on which is computer-readable data 804. This computer-readable data 804 in turn includes a set of processor-executable instructions 806 configured to operate according to one or more of the principles set forth herein. In some embodiments, the processor-executable instructions 806 may be configured to cause a computer associated with the tractor 102 (FIG. 1) to perform operations 808 when executed via a processing unit, such as at least some of the example method 700 depicted in FIG. 7. In other embodiments, the processor-executable instructions 806 may be configured to implement a system, such as at least some of the example control system 120 depicted in FIG. 1. That is, the control system 120 may include or be connected to the implementation 800 of FIG. 8. Many such computer-readable storage media may be devised by those of ordinary skill in the art that are configured to operate in accordance with one or more of the techniques described herein.

All references cited herein are incorporated herein in their entireties. If there is a conflict between definitions herein and in an incorporated reference, the definition herein shall control.

While the present disclose includes certain illustrated embodiments, those of ordinary skill in the art will recognize and appreciate that it is not so limited. Rather, many additions, deletions, and modifications to the illustrated embodiments may be made without departing from the scope of the following claims, including legal equivalents thereof. In addition, features from one embodiment may be combined with features of another embodiment. Further, embodiments of the disclosure have utility with different and various agricultural machine types and configurations.

1. An agricultural implement, comprising:
a frame;
a center toolbar carried by the frame and carrying a first ground-engaging row unit;
a first sensor configured to sense a position of the first ground-engaging row unit relative to ground;
an intermediate member pivotally coupled to the center toolbar;
a wing toolbar pivotally coupled to the intermediate member and carrying a second ground-engaging row unit;
a second sensor configured to sense a position of the second ground-engaging row unit relative to the ground;
a first actuator configured rotate the intermediate member relative to the center toolbar;
a second actuator configured to rotate the wing toolbar relative to the intermediate member; and
a control system configured to control the first actuator and the second actuator based at least in part on the sensed positions of the first and second ground-engaging row units when the implement is in a field-operation mode.

2. The agricultural implement of claim 1, wherein the first actuator comprises a hydraulic cylinder.

3. The agricultural implement of claim 1, wherein the second actuator comprises a hydraulic cylinder.

4. The agricultural implement of claim 1, wherein the control system is configured to maintain the second row unit at a same position relative to the ground as the first row unit.

5. The agricultural implement of claim 1, wherein the control system is configured to receive a signal to switch from the field-operation mode to a transport mode, wherein the control system is configured in the transport mode to cause the first and second actuators to position the wing toolbar at least partially above the center toolbar.

6. The agricultural implement of claim 1, wherein the first ground-engaging row unit is coupled to the center toolbar by a first parallel linkage, and wherein the second ground-engaging row unit is coupled to the wing toolbar by a second parallel linkage.

7. The agricultural implement of claim 6, wherein the first sensor comprises a rotary sensor configured to measure an angle of an element of the first parallel linkage, and wherein the second sensor comprises a rotary sensor configured to measure an angle of an element of the second parallel linkage.

8. The agricultural implement of claim 1, wherein the first sensor and the second sensor each comprise an ultrasonic, lidar, or radar sensor.

9. The agricultural implement of claim 1, wherein the control system comprises at least one component selected from the group consisting of a control valve, an air valve, an electronic control component, a magnetic control component, and an electromagnetic control component.

10. The agricultural implement of claim 1, wherein the intermediate member carries no ground-engaging row units.

11. The agricultural implement of claim 1, further comprising a first angle sensor configured to determine an orientation of the intermediate member relative to the center toolbar.

12. The agricultural implement of claim 11, further comprising a second angle sensor configured to determine an orientation of the wing toolbar relative to the intermediate member.

13. The agricultural implement of claim 1, further comprising:
another intermediate member pivotally coupled to the center toolbar;
another wing toolbar pivotally coupled to the another intermediate member and carrying a third ground-engaging row unit;
a third sensor configured to sense a position of the third ground-engaging row unit relative to the ground;
a third actuator configured rotate the another intermediate member relative to the center toolbar; and
a fourth actuator configured to rotate the another wing toolbar relative to the another intermediate member;
wherein the control system is configured to control the third actuator and the fourth actuator based at least in part on the sensed positions of the first and third ground-engaging row units when the implement is in the field-operation mode.

14. A computer-implemented method for operating an implement that comprises a frame, a center toolbar carried by the frame and carrying a first ground-engaging row unit, an intermediate member pivotally coupled to the center toolbar, and a wing toolbar pivotally coupled to the intermediate member and carrying a second ground-engaging row unit, the method comprising:
receiving an indication of a position of the first ground-engaging row unit relative to ground sensed by a first sensor;
receiving an indication of a position of the second ground-engaging row unit relative to the ground sensed by a second sensor;
causing a first actuator to rotate the intermediate member relative to the center toolbar; and
causing a second actuator to rotate the wing toolbar relative to the intermediate member;
wherein the first actuator and the second actuator are controlled based at least in part on the sensed positions of the first and second ground-engaging row units when the implement is in a field-operation mode.

15. The computer-implemented method of claim 14, further comprising sensing a position of the center toolbar relative to the ground and sensing a position of the wing toolbar relative to the ground.

16. The computer-implemented method of claim 14, wherein causing the first actuator to rotate the intermediate member relative to the center toolbar comprises sending a first control signal to a first control component associated with the first actuator, and wherein causing the second actuator to rotate the wing toolbar relative to the intermediate member comprises sending a second control signal to a second control component associated with the second actuator.

17. The computer-implemented method of claim 14, wherein receiving the indication of the first position of the first ground-engaging row unit relative to the ground sensed by the first sensor comprises receiving a first signal from the first sensor, and wherein receiving the indication of the second position of the second ground-engaging row unit relative to the ground sensed by the second sensor comprises receiving a second signal from the second sensor.

18. A non-transitory computer-readable storage medium, the computer-readable storage medium including instructions that when executed by a control system associated with an agricultural implement that comprises a frame, a center toolbar carried by the frame and carrying a first ground-engaging row unit, an intermediate member pivotally coupled to the center toolbar, and a wing toolbar pivotally coupled to the intermediate member and carrying a second ground-engaging row unit, cause the control system to perform the computer-implemented method of claim 1.
